(19) United States
(12) Patent Application Publication
(10) Pub. No.: US 2022/0343766 A1
(43) Pub. Date: Oct. 27, 2022

(54) METHOD FOR ASSISTING IN THE PILOTING OF AIRCRAFT

(71) Applicant: THALES, COURBEVOIE (FR)

(72) Inventors: Laurent FLOTTE, TOULOUSE (FR); Sylvain YAN, TOULOUSE (FR); Amandine AUDOUY, TOULOUSE (FR); Valentin DUPONT, TOULOUSE (FR)

(21) Appl. No.: 17/706,525

(22) Filed: Mar. 28, 2022

(30) Foreign Application Priority Data
Mar. 29, 2021 (FR) 2103184

(51) Int. Cl. G08G 5/00

(52) U.S. Cl. CPC G08G 5/003; G08G 5/0021

(57) ABSTRACT

A method for assisting in the piloting of an aircraft during a mission, the method being implemented by computer and includes a step of calculating events by a plurality of application components or capabilities, each capability having a competency domain and being configured according to one and the same logic format, the events being calculated based on data acquired from various certified or non-certified avionics sources and/or from various sources external or internal to the aircraft; a step of calculating the impact on carrying out the current mission of the aircraft, based on at least one calculated event; an impact processing step; and a step of determining at least one solution for adapting the current mission of the aircraft.

### CROSS-REFERENCE TO RELATED APPLICATION

This application claims priority to foreign French patent application No. FR 2103184, filed on Mar. 29, 2021, the disclosure of which is incorporated by reference in its entirety.

### FIELD OF THE INVENTION

The technical field of the invention is that of aircraft mission management, and the invention relates more particularly to a method for assisting in the piloting of aircraft.

### BACKGROUND

In aircraft of increasing complexity, the strategic management of an aircraft's mission, whether civil or military, involves an increasingly heavy workload on pilots, in particular when an event arises, whether internal to the aircraft (such as a system failure or a medical issue with a passenger) or external thereto (such as a change in the weather or damage to infrastructure), or else operational (for example, a change to the mission as originally planned).

The management of an aircraft and of its environment is currently based on three types of known avionics systems: Alert- or “Flight Warning System” (FWS)-type systems, Management or “Flight Monitoring System” (FMS)-type systems, and Monitoring-type systems.

Alert (FWS)-type systems are currently implemented in all types of aircraft. They serve a dual purpose: to alert the pilot when an abnormal situation arises and, where applicable, to present them with the procedures for dealing with the failure in order to bring the situation back under control, ensuring flight safety and the return of the aircraft to the ground.

In some, more elaborate systems, the FWS also proposes a list of inoperative systems (“INOP SYS”) and actions, to be dealt with later, to cover the repercussions of the failure on the rest of the mission (“DEFERRED PROCEDURE/LIMITATIONS”). In current aircraft, systems are increasingly interconnected, and the number of failures that may be generated by the system may be relatively large. In this case, it is the pilot who has to interpret and manage all of the information and the limitations which may be applicable to their situation.

Additionally, it should also be noted that in current FWSs, the information to be presented to the crew is determined statically by way of an analysis which is carried out during the design of the system and of the aircraft. This analysis is carried out while considering all of the aircraft's missions including worst-case scenarios, which is not necessarily the case of the current mission.

A number of Management (FMS)-type systems are known.

There are “Route Solver”-type devices, which aim to calculate a safe route with respect to the relief and the weather. This calculation does not take into account the state of the aircraft and its restrictions.

There are guiding devices which aim to calculate a route for guiding the aircraft. These devices guide the aircraft, potentially while checking the active path and triggering an alert for the crew or a reconfiguration when the situation deteriorates. This type of device only covers the current flight plan calculated by the device and no alternative flight plans.

There are devices for making the path safe which aim to make the path safe with respect to certain threats. In this case too, these devices generally do not take into account the state of the aircraft and its restrictions.

A number of Monitoring-type systems are also known, such as Traffic Collision Avoidance Systems (TCAS), Terrain Awareness and Warning Systems (TAWS), Weather Radar systems or International Space Station (ISS) systems. The aim of these systems is to trigger alerts if an aircraft is too close to a hazardous situation from the point of view of traffic, of terrain and of weather, respectively. They therefore address a tactical situation more than a strategic one and they notably do not allow an alternative flight plan/path to be considered.

With the various systems of the prior art, when there is a change in the state of the aircraft or an external event occurs, the pilot has to analyse the information provided and devise a strategy for adapting the mission which they consider to be optimal.

Most of the time, the pilot has to make do with analysing a subset of data that they consider to be relevant, as they have neither the time nor the capacity to reconsider the overall context, there being too much information. Thus, the pilot generally just assumes that the only changes with respect to the initial situation are those which triggered the analysis. However, this is not necessarily the case. For example, the weather at one of the possible alternate airports may have changed between flight preparation and the flight itself, thereby making the solution of diverting to this airport inoperable.

Lastly, among the means at their disposal, other than the alert or monitoring systems mentioned above, the pilot may consult the aircraft documentation of QRH (“Quick Reference Handbook”) type, either in paper format or digitalized as an EFB (“Electronic Flight Bag”), with a view to finding the main elements and information to be taken into account and to cross-check in order to analyse the situation.

Thus, the known assist systems aim to provide aid to the pilot to help them with analysing the impact of a change in context in a current mission.

The known approaches are primarily focused on presenting information to the crew. The patents U.S. Pat. No. 10,096,253 entitled “Methods and systems for presenting diversion destinations” and U.S. Pat. No. 10,109,203 entitled “Methods and systems for presenting en route diversion destinations”, propose such approaches. However, they do not provide proposals based on multiple criteria.

Moreover, the known assist solutions are instead based on defining a score which allows the pilot to see the status of various possible alternate airports, but they do not describe how to arrive at the solution.

Lastly, existing systems are either purely avionic systems subject to certification constraints on hardware and software, or “open-world” systems, also called non-avionic systems, which are systems not subject to the same certification constraints. Open-world systems cover hardware that may host software which is not certified but is subject to “OPS-Approval” by the operator. The open world has the advantage of having fewer constraints on development, with shorter development and deployment processes and, lastly, a possible connection to “cloud”-type servers which may share data via the Internet. In other words, with reference to the Arinc 811 standard, “avionics” is in the “CLOSED” category while, conversely, “Open World” is not in the “CLOSED” category.

Avionics systems primarily handle tactical and safety aspects of a change in context, i.e. they are oriented towards an immediate reaction that the pilot should have, and they do not analyse the medium-/long-term consequences. Even if these systems evolved to integrate suggestion capabilities, they would quickly find themselves limited in terms of computing power and also in terms of capabilities for collecting new data.

Open-world (and therefore non-certified) systems are not connected to the avionics. They therefore have a fragmentary view of a current situation because they do not continuously integrate the state of the aircraft and change in the envisaged mission.

Thus, to allow a pilot to take a decision, current systems do not take into account all of the information from the aircraft or from various services from the open world. The information that the pilot receives is then fragmentary and does not allow them to take a decision with an overall view of flight context and of environmental context.

Thus, there is a need for advanced assist systems and methods for aiding a pilot in analysing, following the occurrence of an event, the impact of a change in context on the aircraft's current mission.

Such systems and methods should make it possible to correlate all of the information available and make it possible to provide a pilot, and a crew, with the best options in order to allow them to take a decision.

### SUMMARY OF THE INVENTION

One subject of the present invention is a method for assisting a crew which makes it possible to analyse and then to correlate, in a reliable manner, all of the relevant information relating to an aircraft, and its environment, in order to determine whether a current situation has to be adapted and, if so, to propose solutions which appear to be most relevant for this adaptation.

Another subject of the invention is a method for assisting in piloting which makes it possible to retrieve context data from various sources (i.e. the aircraft's avionics, ground data, open-world data); to construct a coherent overall context; to identify differences between this context and the initial context of the mission as envisaged; and to address these differences by proposing various alternatives, in order to allow the pilot to choose from among the proposed alternatives or to study other alternatives.
In general, the proposed solution allows a crew (one or more pilots): assistance in taking account of changes in the environment affecting a mission; to decrease the time spent on performing repetitive activities without much added value, by preparing and anticipating certain tasks;
to decrease human error, by implementing reminders and contextualized assistance;
assistance in meeting the expectations of passengers and operators.

Advantageously, the method of the invention may work for any avionics without the principles and the concepts described and used in the suggestion mechanisms being affected.

To obtain the desired results, what is proposed is a method for assisting in the piloting of an aircraft during a mission, the method being implemented by computer and comprising:

a step of calculating events by a plurality of application components or capabilities, each capability having a competency domain and being configured according to one and the same logic format, said events being calculated based on data acquired from various certified or non-certified avionics sources and/or from various sources external or internal to the aircraft;

a step of calculating the impact on carrying out the current mission of the aircraft, based on at least one calculated event;

an impact processing step; and

a step of determining at least one solution for adapting the current mission of the aircraft.

According to some alternative or combined embodiments: the step of calculating the impact comprises steps of:
calculating a current context of the current mission according to said at least one event; and
determining, according to the current context, the impact on carrying out the current mission.

the determination step comprises calculations based on predefined rules and/or calculations based on an ontology.

the step of processing the impact comprises steps of:
constructing solution requests according to the calculated impact; and
sending said solution requests in order to query capabilities according to their competency domain.

the step of determining a solution for adapting the mission additionally comprises steps of:
evaluating the relevance of the solution proposals received from said queried capabilities;
sorting said proposals; and
constructing a solution for adapting the current mission of the aircraft
according to the evaluation and the sorting of said proposals.

the evaluation step comprises steps of:
calculating a resulting context for the current mission for the evaluated solution; and
determining, according to the resulting context, the impact on carrying out the current mission.

the determination step comprises calculations based on predefined rules and/or calculations based on an ontology.

the method further comprises a step for displaying the one or more solutions for adapting the current mission of the aircraft on a human-machine interface.

the method comprises steps for recording the competency domain of each application component in a capability register and a capability database.

The invention also relates to a device that comprises means for implementing the method of the invention.

The invention also relates to a computer program product comprising code instructions allowing the steps of the method for assisting in the piloting of an aircraft of the invention to be carried out when the program is run on a computer.

### BRIEF DESCRIPTION OF THE DRAWINGS

Other features and advantages of the invention will become apparent with the aid of the following description and the figures of the appended drawings, in which:

FIG. 1 is an exemplary architecture of a device for assisting in piloting allowing the method of the invention to be implemented;

FIG. 2 is a flowchart of the main steps in the method for assisting in piloting of the invention;

FIG. 3 details the steps of the method of the invention for determining the execution of the mission during an event;

FIG. 4 details the steps of the method of the invention for determining a solution for adapting the current mission of an aircraft;

FIG. 5 details the steps of the method of the invention for evaluating a solution proposal;

FIG. 6 illustrates the steps of recording a capability according to the method of the invention;

FIG. 7 illustrates the steps of processing a solution request according to the method of the invention; and

FIG. 8a, FIG. 8b and FIG. 8c illustrate exemplary implementations of the device for assisting in piloting of the invention.

### DETAILED DESCRIPTION

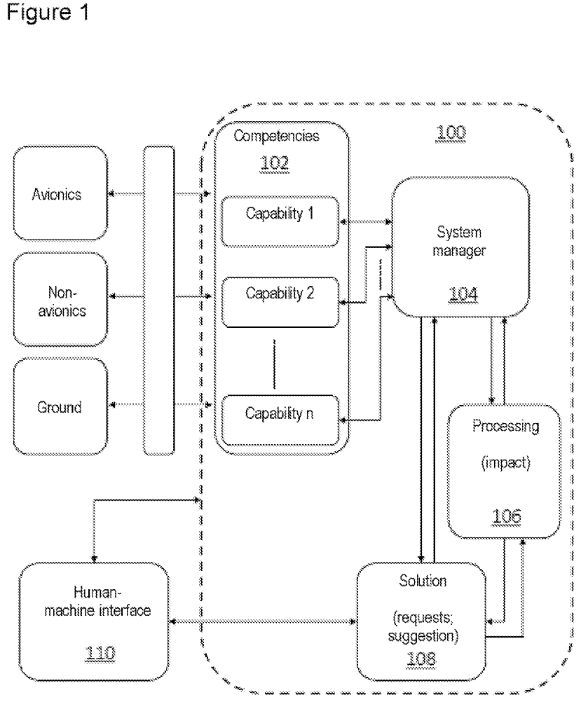

FIG. 1 illustrates an exemplary architecture of a device for assisting in the piloting of an aircraft allowing the method of the invention to be implemented. The device (100) for assisting in the piloting of an aircraft of the invention generally comprises at least one competency module (102), a management module (104), a processing module (106) and a solution module (108).

The management module (104) is configured to manage conflicts and priorities of streams passing between various modules and to direct the exchanges between the various modules of the device.

The processing module (106) is configured, on the one hand, to determine what the potential impacts of events on the current mission are (calculated by the application components) and, on the other hand, to carry out checks on the relevance of solutions generated by the application components for adapting the current mission, if there are impacts.

The solution module (108) is configured to send solution requests in order to query application components, evaluate, via the processing module, the relevance of solution proposals, and construct a solution for adapting the current mission.

The solution may be presented on a human-machine interface HMI (110) which is configured to manage the various human-machine interactions in the context of using the device for assisting in piloting of the invention.

The HMI (110) is configured (i.e. comprises various interfaces adapted to the type of interaction) to allow one or more operators to interact with various modules of the assisting device or “Assistant”, and with various services and/or components of the avionics and/or from the open world, on board and/or on the ground.

The interactions and information that are exchanged take place via various interface configurations which are, at least:

an “Operator (pilot)/Assistant”-configured interface for soliciting the Assistant in various ways (multimodality): natural language, touch, “Eye tracking”, sound/acoustic alarm, microgesture, but also through computer requests (notifications).

an “MRO” (“Maintenance Repair & Overhaul”)-configured interface for interacting with a maintenance, repair and overhaul service:

In the MRO→Assistant direction:
Exchange of maintenance capabilities per airport.
“Spare” available per centre.

In the Assistant→MRO direction:
Sending detected failures.

an “ATC” (“Air Traffic Control”)-configured interface for interacting with air traffic control:

In the ATC→Assistant direction, sending:
“D-NOTAM” (“Digital Notice To AirMen”) or digital-format information which is a message published by government agencies for air navigation control for the purpose of informing pilots of events (changes, closures, failures, work, forbidden areas, etc.) in infrastructure. When preparing to fly, the pilot has to consult them in order to check the safety of their mission. ATC instructions.
“D-ATIS” (“Digital Automatic Terminal Information Service”) which is an automatic broadcast service allowing pilots to continuously receive (new recording generally every half hour) information on the most used airports. These messages may in particular contain weather data, runways in service, available approaches, etc.

in the Assistant→ATC direction, sending:
Signalling hazardous weather situations (windshear, turbulence, freezing conditions).

an “Environment”-configured interface for interacting with weather services able to provide environmental data:

In the Ground→Assistant direction, sending:
Weather (“wind”, “windshear”, temperature, convections, “icing”, “ASHTAM” which is a special NOTAM for describing the status of the activity of a volcano when this might affect flight progress/safety, “SNOWTAM” which is a special NOTAM relating to snowed-up conditions on an airport's runways, etc.).
“Weather uplink” (en route), which is a message transmitted via the Datalink (ground/plane link) containing weather information (winds, temperatures) on the points of the planned path.
“METAR” for “METeorogical Aerodrome Report” which is a report on the weather conditions as observed from the ground at an airfield, “TAF” for “Terminal Aerodrome Forecast” which is a weather forecast valid for 6 to 30 h for an airfield, using similar coding to the METAR format, at airports.
Weather conditions at the arrival airport and possibles alternate airports.
States of planned and possible landing runways (contamination level, presence of rain, snow, etc.).
Traffic around the aircraft (air+ground).

a “Mission”-configured interface for interacting with systems able to provide data relating to the aircraft's mission:

In the Avionics→Assistant direction, sending:
Active flight plan
Required operational capabilities to carry out the mission (takeoff type, approach type, etc.).
Remaining flight time.
Fuel on board
Weight
Changes to the flight plan from the avionics
Current position of the aeroplane

In the Assistant→Avionics direction, sending:
Flight plan suggested by the Assistant and chosen by the pilot
Performance factor (“Perf Factor”)
Performance loss factor (thrust loss, aerodynamic drag, braking distance).

a “systems”-configured interface for interacting with systems able to provide data relating to the state of the aircraft's systems:

In the Avionics→Assistant direction, sending:
List of inoperative systems.
Alerts detected.
Pilot actions on the “FWS” (“Flight Warning System”) procedures.
States/position of certain systems (position of slats and flaps, “anti-ice” active or inactive).

In the Open-world application→Assistant direction, sending:
Limitations/restrictions identified in the “e-Logbook”. “MEL”.

In the Assistant→Open-world application direction:
Failures detected for the e-Logbook.

In the Assistant→Avionics direction:
Flight envelope restriction (speed, altitude)
Actions on the controls and associated timing (activation of de-icing, etc.).

The data required by the device of the invention are:

Airport database (airport position, runway characteristics, takeoff and landing procedures, classification in terms of difficulty (due to terrain, to traffic)).

Database containing safety altitudes.

Infrastructure associated with the airport (hotel, repair centre, transport means).

Geopolitical map and associated constraints (visa).

Database containing inoperative systems↔operational limitations associations.

Landing/takeoff performance database.

Consumption database.

The data exchanged with the ground for the requirements of the device of the invention are:

Suggestions made

Pilot choice

Associated contexts

Pilot requests

Pilot modifications made based on suggestions

Difference between suggestions and flight made/flight data

Internal algorithmic data (for example, suggestions made on a version N+1 of the Assistant “ghost mode”).

The competency module (102) comprises a plurality ‘n’ of application components, also referred to as capabilities (capability₁, . . . capabilityᵢ, . . . , capabilityₙ). Each capability is configured according to one and the same logic format in order to perform at least three types of functions, namely:

declaring a competency domain;

calculating events;

processing solution requests and generating solution proposals.

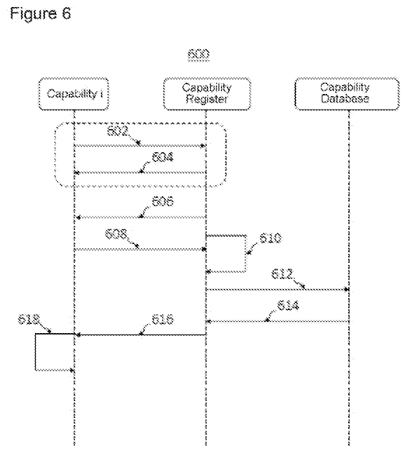

To be active, an application component has to be declared. The competency domain of a capability is declared and recorded in a competency register in order to indicate the functional domain of the application component, the nature of the data relating to this functional domain, the type/format of data of which the capability will have need to exercise the functions of calculating events and of processing requests, and the type/format of data that the capability will produce, according to a method illustrated in FIG. 6.

FIG. 6 shows the steps of recording a capability according to the method of the invention, which consists in:
602-604: Checking the presence/the current operation of the “capability register” component: until it responds, it will continue to be polled by the “capability i” component at regular intervals.
606: When an OK status response is received from the “capability register”, the next part of the recording process proceeds.
608: The “capability i” component sends the “capability register” all of the generic information regarding it (information which may be referred to as being a “work placement contract”) and which will allow: the competency to be put on the cases for which it might be applicable; it to be provided with the inputs of which it might have need in that case; and the responses that it provides to be retrieved.
610: The capability register checks that the data sent to it by the capability do indeed correspond to the required format/model, which all of the capabilities have to observe (thus targeting an objective of modularity for adding capabilities).
612: Once the checks have been carried out, the competency of the capability is recorded in the capability database which stores all of the competencies recorded with the competency register.
614: The capability database confirms the recording once it has been carried out correctly.
616: Once recording has been carried out correctly in the capability database, the capability register informs the capability i that its recording has been successfully carried out.
618: The capability i, which has been recorded correctly, then waits for a request.

In one embodiment, the competency module (102) comprises at least an “Avionics systems management” capability, an “Environment management” capability, and a “Mission management” capability.

The general function of the “Avionics systems management” capability is to know the aircraft's status, and thus:
to collect the state of aircraft systems from the avionics portion.
to determine the operational limitations according to the state (actual or imposed by the pilot after a “what if” simulation) of the avionics systems. A “what-if” test is a simulation of what would happen if an event took place.
to check the compatibility between a change in situation (for example: a change in flight plan requested by the pilot/caused by a change in environmental context) and the state (actual or imposed by the pilot) of the machine.
to transmit instructions/objectives to the systems of the aircraft (change in the state of a system, action on the system).
to monitor the correct execution of the instruction, the achievement of objectives.

In one implementation, the architecture of the “Avionics systems management” capability is based on multiple functional components which are a “System Management Driver”, a “System Management Service” and a “System Management Skill”.

The “System Management Driver” is configured to perform the role/function of abstracting the architecture with respect to the utilities of the systems in order to “trivialize” the link between an inoperative system and the resulting limitations. Specifically, FCOM (“Flight Crew Operating Manual”) analyses carried out on various carriers show that the operational limitations are more or less of the same type regardless of the carrier. However, since the architecture of the systems differs from one carrier to the next, the limitations may be triggered by different root causes (for example, a single or double failure). Additionally, the components of the systems rarely have the same designations from one carrier to the next. Thus, advantageously, the “System Management Driver” module makes it possible to overcome this issue by absorbing the associated variability. To do this, each inoperative system is associated with a failure family and a trivialized limitation family, per configuration file.

One non-limiting example is given for the engine failure family “Family=Engine”, for which an associated root cause may be “Fault=Engine 1 System” and a resulting limitation may be “Delay Take Off”, where the parameters are no longer associated with a specific aircraft, and become generic parameters.

This “trivialization” component thus makes it possible to acquire all of the required data while overcoming the constraints inherent to the carrier (data name, source selection logics). This is the case, for example, for data such as aeroplane mass, heading, radio frequencies, fuel flow, etc.

The “System management Service” is configured to perform multiple roles or functions, which are:
storing the state of the various systems and data received from the avionics and various other data. This state may either be received directly from a FWS (i.e. a list of inoperative systems) or be deduced from pilot actions on the procedures (i.e. a system may, for example, be operating correctly but be turned off to reduce electricity consumption, which may cause limitations). This storage is made necessary by the fact that the received information may reflect not the state of the aircraft but the modifications made thereto and change with time (for example, the fuel on board which may be used in addition to the failure information to evaluate the extent/change in a fuel leak. In a normal situation, this information makes it possible, for example, to determine that the pilot has selected a particular command which is not directly found in the system state data (de-icing activated for example).
consolidating and calculating the impact of the limitations. Based on the list of inoperative systems, it establishes a list of limitations (for example, if two faulty systems produce a limitation on the same capability—runway length for example—it produces an overall result). To do this, this component incorporates a configurable mechanism for calculating logics/values which makes it possible to define the processing to be applied to limitations of the same nature. One possible solution is that provided by the “Detection” component of the FWS. Depending on the case, for example, speed limitations may build up or else it may be necessary just to take the most disadvantageous.

Thus, the following services are, for example, identified (non-exhaustive list):
performance factor. This factor makes it possible to say, according to the detected failure, by how much the aircraft will consume in excess with respect to normal.
required runway length: This information makes it possible to determine the length required for the aircraft to land according to its state, its mass and the weather conditions.
approach minima: This information makes it possible to say, depending on the state of the aircraft, which minima are attainable.
flight envelope reduction: This information makes it possible to identify whether, depending on its state, the aircraft is limited in terms of altitude, speed, roll and takeoff/landing configuration.

The “System management Skill” has the following roles or functions:
consolidating the state of the aircraft: Based on the information produced by the “System Management Service”, and once it has determined that the aircraft is in a stabilized state, it generates a notification to inform of modifications made/undergone by the aircraft.
checking, based on information on the state of the systems, whether a change in context is compatible from the the point of view of the state of the aircraft (“Check System State Compliance”), such as, for example, a change in the flight plan to go from a CAT3a landing to an LPV procedure: can the aircraft perform LPV? This mechanism is necessary to ensure that limitations that had no impact or had a different impact when they occurred are taken into account retroactively. For example, the loss of the LPV capability is without impact if this capability is not envisaged in the initial mission but makes changing the flight plan impossible if it is required in the intended change.
querying the capability to evaluate the impact of an imaginary loss imposed by the pilot on the state of the machine (“Simulate What If”).

The “Environment management” component has the following function:
collecting, capturing, consolidating and storing the environmental situation and the environmental data via the ground/plane connectivity:
   from ATC: D-NOTAM (states of the guidance and communication means, Flight restrictions), ATC, D-ATIS (states of runways, airport services) instructions, traffic around the aircraft;
   from weather services: Weather (wind, windshear, temperature, convections, icing, ASHTAM, SNOWTAM, etc.), weather “en route”, METAR, TAF and states of runways at the destination and possible alternate airports.
checking the compatibility between a change in situation (for example: a change in flight plan requested by the pilot/caused by a change in the state of the machine) and the environmental context (windshear, NOTAMs, etc.)

The “Mission management” capability is linked to the applications providing the weather data relating to the flight and thus has the following function:
collecting the mission data from the avionics portion.
checking the compatibility between a change in situation (for example: a change in flight plan requested by the pilot/caused by a change in environmental or aircraft context) and the characteristics of the mission (destination, amount of fuel, flight profile).
determining modifications to the mission that are likely to be compatible with the environment and the state of the aircraft (actual or imposed by the pilot: “what if”). transferring the mission modifications selected by the crew to the avionics portion.

In one implementation, the architecture of the “Mission management” capability is based on multiple functional components which are an “FMS Driver”, a “Leg Services”, and a “Mission Skill”.

The role of the “FMS Driver” is to abstract the mission management system (for example an FMS) from the aircraft, and it makes possible:
retrieving information on the current mission such as, for example, the flight plan of the current mission, the approach type and the amount of fuel on board the aircraft.
transferring flight plan modifications arising from the proposed suggestions. To do this, it converts the received solution requests to the protocol format expected by the FMS present on board.

The “Leg Services” has the role of:
storing the current flight plan and broadcasting the information. By virtue of this, it allows the various capabilities and services to access the flight plan data by managing concurrent accesses to the information.
promoting and transmitting mission modifications arising from the suggestions to the avionics. To do this, the component interfaces with the “FMS Driver”.

The “Mission Skill” has the role of:
producing a notification once the state of the mission is stabilized.
ensuring the conformity of the mission (“Check Mission Compliance”) with a change in context due to the environment (for example, a diversion to avoid a poor weather situation) or the state of the machine (for example, excess consumption). To ensure conformity, a simple comparison is made between what is envisaged and the current context increased by a margin. Thus, access to the following mission data is necessary:
   remaining flight time (in case of fuel leak, depressurization, for example) amount of fuel, amount expected on arrival (fuel leak)
   expected approach and takeoff category (ILS, GLS, LPV, RNP AR, etc.) expected runway and associated length
   cruising altitude (flight envelope limitation)
   max horizontal and vertical speed (flight envelope limitation).
evaluating and proposing a solution in the event of context change (“Compute Mission Update”). Unsecured elements (ground infrastructure for example) are used as sorting criteria between various suggestions. The following services are identified as being necessary:
   adding additional time: makes it possible to evaluate the feasibility (arrival within the time, weather risk) and the cost caused (excess consumption) by a delay.
   defining an alternate airport according to:
      the maximum flight duration (in case of fuel leak, depressurization, for example).
      the amount of fuel (leak)
      available approach categories (limitation preventing an ILS, GLS, LPV, RNP AR, etc. approach)
      the required landing distance (limitations on the braking system).
   defining a lateral avoidance according to:
      the weather
      the fuel on board
      the target time of arrival
      the definition of a flight plan modification (vertical or horizontal) according to flight envelope restrictions (speed, altitude).

According to some variant embodiments, the competency module (102) may comprise other capabilities, such as, for example, non-limitingly: an “ATC” capability charged with (i.e. its competency domain, its function) decoding “datalink ATC” messages;
a multimodality capability translating ATC instructions—voice;
a capability whose competency domain (its function) is retrieving maintenance information;
a capability whose competency domain (its function) is capturing pilot selections and tracking them over time by monitoring the associated parameters.

Thus, advantageously, the method of the invention allows, via the competency register, the addition and/or the removal of application components. Each component, once recorded according to its competency domain, may organize the requests to the various respective services and systems (avionics; non-avionics; ground) allowing the functions of event calculation and request processing to be performed.

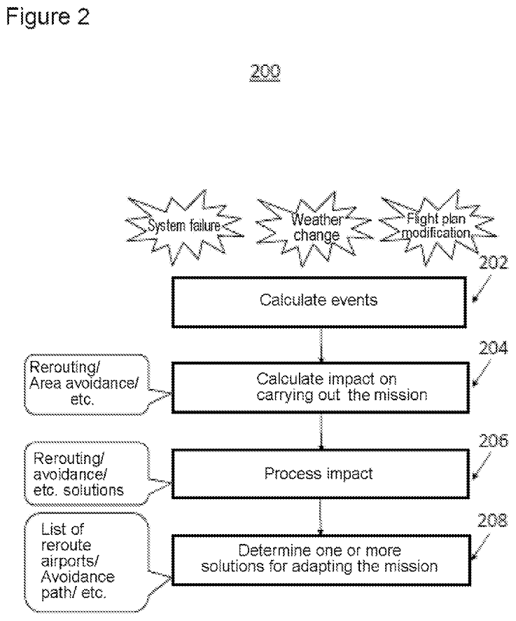

FIG. 2 shows a flowchart of the main steps of the method for assisting in piloting of the invention. The method (200) is, for example, implemented through the various modules of the device illustrated and described with reference to FIG. 1.

A first step (202) of the method generally consists in calculating events by means of the active capabilities of the competency module.

The “event calculation” function of a capability is responsible for consolidating a set of information received from various sources (certified avionics; non-avionics; ground; sources external and/or internal to the aircraft), before sending an event notification for subsequent processing thereof by the processing module. The “event calculation” function is configured to prevent mass processing requests and to ensure that the most relevant notifications are sent. Specifically, it is necessary to ensure that the context leading to an event notification corresponds to a stable state. For example, an “engine” failure will result in the loss of multiple systems. This loss is not simultaneous. It is therefore necessary to wait for the situation to stabilize before notifying. If this is not done, the risk is that non-relevant calculations and suggestions will be given to the pilot due to taking into account only part of the situation which is not yet stable. Thus, the event calculation function of each capability may be parametrized to take account of the competency domain of the capability and therefore the information to be collected, and allow information consolidation specific to each capability.

Thus, for the “Avionics systems management” capability, the event calculation function essentially consists in calculating operational limitations of the aircraft, such as, for example, the failure of a system.

For the “Mission management” capability, the event calculation function essentially consists in generating mission data, such as, for example, a flight plan modification.

For the “Environment management” capability, the event calculation function essentially consists in calculating weather events, such as, for example, a change of weather.

When at least one event notification is issued by a capability, the method continues on with an impact calculation step (204), consisting in determining whether the event may have an impact on carrying out the current mission.

In the case of multiple concomitant events, the method allows event priorities to be managed (via the management module 104), so as to deal with the event deemed highest priority first.

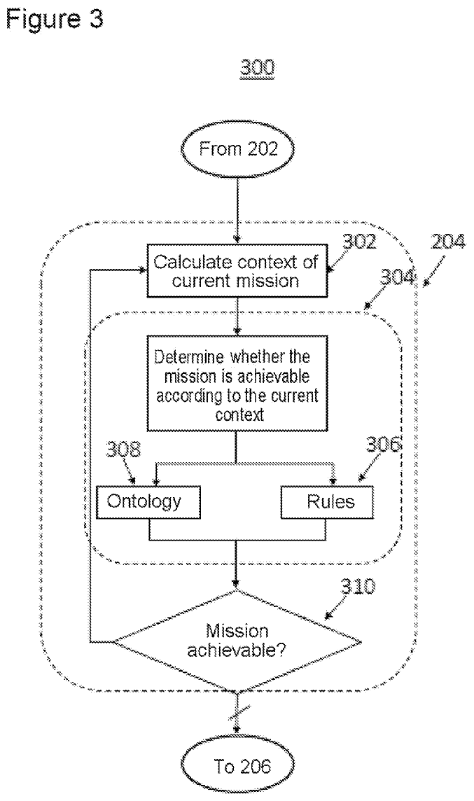

FIG. 3 details the steps implemented by the method of the invention for processing an event, in order to determine whether the event has or does not have an impact on the current mission being carried out successfully.

A first step (302) consists in constructing a view of the current context, i.e. in calculating a current overall context for the aircraft, based on all of the information received via the event notification.

The method continues on with a step (304) consisting in determining whether the current state allows or does not allow the mission to be carried out.

Advantageously, the method makes it possible to perform calculations according to two approaches: calculations based on predefined rules (306) and/or calculations based on an ontology (308).

The method may be parametrized to select either one of the calculation methods or both in parallel, depending on various criteria.

Thus, in one embodiment, a method is selected according to the category of the event to be dealt with, i.e. whether or not the event is critical, whether or not it is obvious, and/or according to the context (flight phase, estimated time, memory allocation, CPU load), leading to a situation of re-evaluation. A grade may be assigned to each method for a given list of possible events.

In one variant embodiment, the method makes it possible to carry out calculations using both methods simultaneously, and to select one of the two results depending on the situation:
if the situation requires a rapid solution and only one method provides a satisfactory result, the result from this method is used.
if the results from both methods are available, the following principle may be considered to synthesize the situation:

if the results are coherent, the method will use the synthesis of both characterizations;

if there are contradictions between the results, the method allows the intersection of the resulting characterizations to be considered, or else the method allows one of the two results to be chosen depending on the initial event (using the same type of method only when a single method is chosen).

The calculations according to predefined rules (306) consist in transmitting, to a rule verification engine, the observations made on the current situation. The rule verification engine may then determine a potential problem affecting the successful execution of the mission.

The rule verification engine is configured so that the predefined rules that have to be verified to ensure that the mission is carried out correctly are formalized in the form of equations which may contain any number or arithmetic, comparison operators and logical operators. The context observations are adapted as accepted inputs in order to correspond to the predefined rules. The rule verification engine executes the rules and provides a result characterizing the situation.

The calculations according to an ontology (308) are based on the implementation of a knowledge-based system. The ontology takes the knowledge of the context and of its evolution and identifies the criteria to be taken into account for the solutions.

From a practical point of view, the use of an ontology makes it possible, in particular by virtue of the work of symbolic artificial intelligence on the knowledge-based systems and the inference engines, to implement deductive reasoning mechanisms and automatic classification mechanisms and to generate implicit knowledge.

In one embodiment, the ontology system comprises: a management core which is configured to manage ontology data, to perform inference calculations and mission coherence checks by virtue of a reasoner, and to introduce additional rules, not defined initially in the structure of the ontology, to the knowledge base fed by the application components for competencies;
a query manager which is configured to query the ontology through queries (which may be queries in the query language SPARQL), and to convert other competency requests into ontology queries.

The ontology comprises at least the following information: Regarding the mission: “FOB”; “Remaining FOB at destination”; “Performance factor”; “Destination Runway Length”; “Remaining Flight Time”; “Weight at destination”; “Wind level at destination”; “Weather at destination”; “Approach Type”; “Approach foreseen Minima”; “Maximum Altitude”; “Maximum Speed”. Regarding the systems: “Altitude Limit Not to exceed”; “Speed Limit Not to exceed”; “Flight Time Not to exceed”; “LAND ASAP”; “LAND ANSA”; “Nominal LDG Distance”; “Required LDG Distance”; “Nominal Fuel Consumption”; “Fuel Consumption”; “Accessible Approach Category”; “Nominal Approach Minima”; “Current Approach Minima”.

Once the calculations have been performed, differences with respect to the feasibility of the mission are identified or otherwise by either or both methods (rules or ontology), resulting in an impact or otherwise on the current execution (step 310). The use of these approaches (ontology or rules) serves to determine whether the calculated current state allows or does not allow the current mission to be carried out: the output of these reasoning operations (310) is an item of information on the feasible or non-feasible status of the mission and, if it is not achievable as it is, it is accompanied with information on the causes for which it is not achievable.

If the result of the reasoning operations does not identify any problem in achieving the current mission, the method loops back to step (302) to wait for a new event/update of the data for the context in order to re-evaluate the status.

If the result of the reasoning operations does identify a problem in achieving the mission, the method continues on (to step 206) with the process of solving this problem in order to produce a suggestion that will make this mission achievable again.

One example of an impact on carrying out the aircraft's current mission may be that rerouting of the aircraft to another airport is requested or else may be that avoidance of an area is recommended.

Returning to FIG. 2, after the impact determination step, the method continues on to a step (206) of processing the impact and then a step (208) of determining a solution for adapting the current mission.

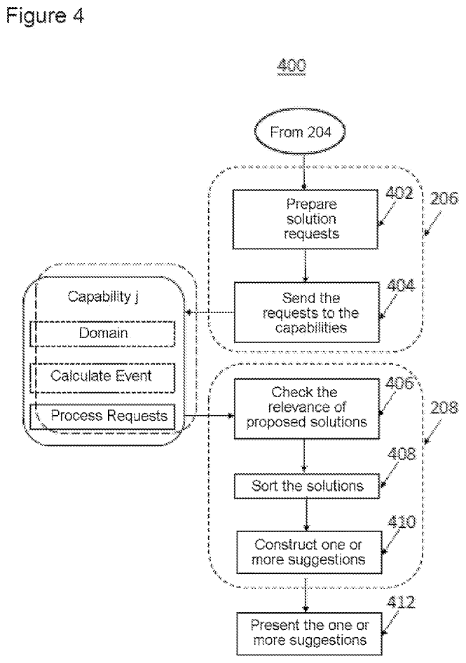

FIG. 4 details the steps of processing an impact on carrying out the mission (206) and the steps of determining (208) a solution for adapting the mission with respect to the impact that has been calculated.

The impact processing consists in preparing (402) solution requests for querying one or more application components according to their competency domain and according to the calculated impact, and then in sending (404) these requests.

In one embodiment, the sending of the solution requests may be done via a routing module, such as, for example, the module (104) of FIG. 1.

Each capability that receives a solution request is configured to handle this request based on data acquired from various certified avionics sources or various non-certified avionics sources, and sources external or sources internal to the aircraft.

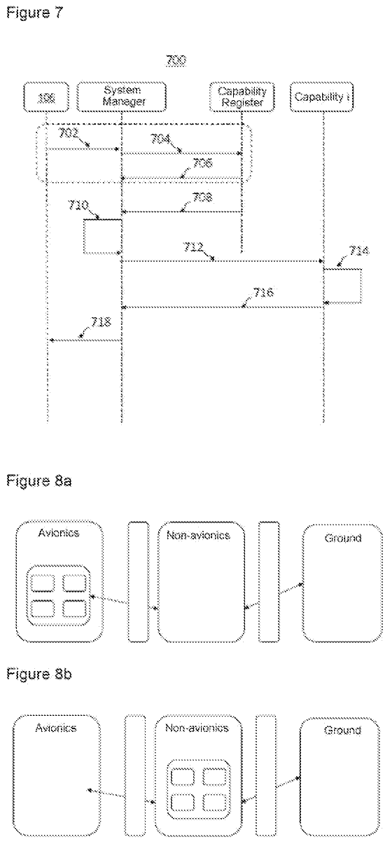

FIG. 7 details the steps of processing a solution request according to the method of the invention, which consist in:
702: Sending a solution request to the system manager (104) which manages access to the various capabilities. It makes it possible to use the functionalities of a capability transparently without needing to know which capability has these functionalities. To do this, it receives the requests and directs them to the appropriate component for handling them.
704-706: Checking the presence/the current operation of the “Capability register” component: until it responds, it will continue to be polled by the system manager at regular intervals.
708: When an OK status response is received from the “Capability register”, the next part of the process for processing the solution request proceeds.
710: The system manager checks that the data in the request correspond to the required format/model for querying the capabilities.
712: Once all of the checks have been carried out, the system manager queries the capability corresponding to the request.
714-716: The queried capability handles the solution request, and sends the result back to the system manager.
718: The system manager sends the received response to the impact processing module (106).

Thus, the “Request processing” function of a capability consists in receiving and then processing these solution requests by calling upon various appropriate services and systems (which may be certified avionics, non-certified avionics, internal or external to the aircraft) to retrieve data, consolidate and return a response.

For the “Avionics systems management” component, the request processing function consists essentially in checking the state of the systems and performing a “what if” simulation (for example, what would the impacts on the aeroplane be if this or that avionics system failed?: “I've lost system 1, I have a suggestion for an alternate route which depends on the use of system 2, what would happen if system 2 were lost? If I have another, more robust alternative in case system 2 is lost, it might be worth favouring that one”).

For the “Mission management” component, the request processing function consists essentially in checking the conformity of the mission, in calculating a mission update and in promoting the flight plan, i.e. providing the flight plan to the avionics systems (FMS in particular) for acceptance.

Checking the conformity of the mission consists essentially in checking that all of the minimum information required for carrying out a mission (e.g. aeroplane type, departure and arrival airport, mass and fuel data, etc.) is available and that the mission is achievable from the point of view of the environment and the state of the aircraft, i.e. the aircraft will not land at an airport with strong winds on arrival if the aircraft is not capable thereof, or reroute to an airport that cannot be reached due to insufficient fuel or due to too high an altitude considering performance.

For the “Environment management” component, the request processing function consists essentially in checking the conformity of the weather, i.e. checking that the weather is compatible with the mission (the mission is achievable under the weather conditions expected on its path and at the airports).

The responses to the solution requests provided by the capabilities are solution proposals for “absorbing” the impact of the event on the mission.

The method then makes it possible (step 406) to check the relevance of the solutions proposed by the capabilities.

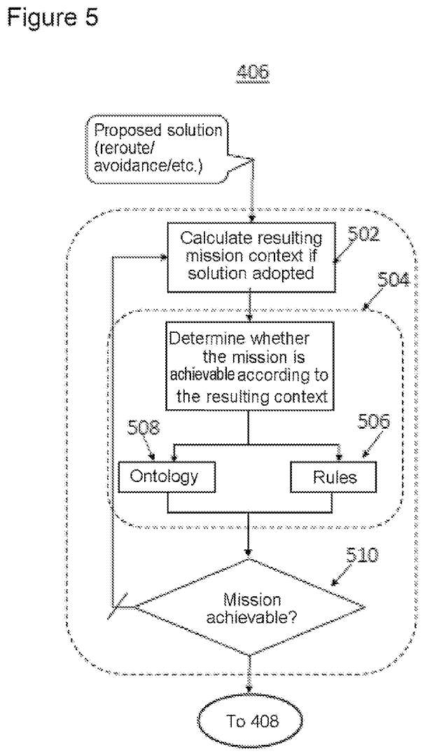

FIG. 5 details the steps of the method for checking the relevance of a solution proposed by a capability, which consist in calculating (502) a context for the mission if the proposed solution is applied, called the “resulting context”. The method continues on with a step (504) of determining any differences present between the initial context of the aircraft and the resulting context. The advantages described above with reference to FIG. 3 for each method also apply to this step (504) for calculating the differences between the initial context and resulting context.

Advantageously, the method makes it possible to calculate the differences present between the initial context of the aircraft and the resulting context in the event that the proposed solution is adopted, according to the two calculation approaches used for the calculation of the difference step (304), i.e. by using a calculation based on predefined rules (506) and/or by using a calculation based on an ontology (508).

In a next step (510), similarly to the method of FIG. 3, according to the identified differences, the method makes it possible to determine what the impact on the mission would be if the proposed solution were implemented.

When the relevance of each solution proposed in response to the solution requests addressed to the capabilities is evaluated, the method continues on with a step (408) of sorting the solutions.

The sorting step makes it possible to weight the solutions found according to sorting criteria adapted to the situation and to the crew issues.

In one embodiment, the selection of the recommended suggestions uses reinforcement learning (a type of machine learning in which the agents take actions in a given environment in order to maximize a cumulative reward).

Based on the synthesis of the situation (resulting mission context), the method allows a list of possible suggestions to be constructed. To be able to select the most relevant suggestions, a grade based on various parameters (for example: fuel consumption, remaining flight time, etc.) is associated with each suggestion and this grade changes with time according to feedback from the pilot (whether or not the suggestion is selected, whether it is modified before insertion, etc.).

By recording the pilot choices that have been made and the associated context, the weighting criteria may be adapted a posteriori so that they fit the situation ever better over time.

In one preferred embodiment, the sorting step allows at least three suggestions to be retained from among the proposed solutions.

A first suggestion may be that which affords the greatest safety margin.

A second suggestion may be that which has the least economical impact for the operator.

A third suggestion may be that which affords the most passenger comfort.

Advantageously, by recording the suggestion information, the method allows the integrated ontology to be enriched in order to make the search for solutions increasingly effective over time.

In a next step (410), the method allows the retained suggestions to be structured so as to be able to notify the crew and present (412) the elements to them with associated rationale.

The pilot or the crew is able to choose the retained suggestion, via the HMI, and then the method allows the information and data corresponding to the pilot's choice to be transferred to the various systems in question to allow the retained adaptation solution to be implemented.

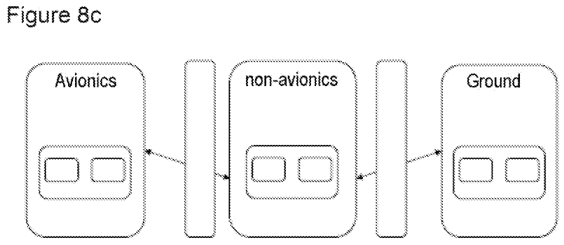

The method (200) is implemented through the various modules of the device of FIG. 1, which may be hosted according to various implementations shown in FIGS. 8a to 8c.

FIG. 8a illustrates one exemplary implementation of the device for assisting in piloting of the invention in which all of the modules are integrated into a certified avionics computing platform.

FIG. 8b illustrates another exemplary implementation of the device for assisting in piloting of the invention in which all of the modules are integrated into a non-certified avionics computing platform.

FIG. 8c illustrates another exemplary implementation of the device for assisting in piloting of the invention in which the modules are distributed between certified avionics computing platforms, non-certified avionics computing platforms and ground infrastructure computing platforms. The ground infrastructure platform is connected to the avionics platform via a data link.

Advantageously, the method described may be implemented via a modular component implementation, these components being easy to update; in particular, new application components may be added to provide new services and enrich the searches for solutions, or be removed as needed.

The method benefits from contributions from the open world in terms of computing power and the volume of data accessible. It makes it possible to consolidate the richness of the collected information and to provide suggestions adapted to the context.

The advantages of the method described are essentially:
modular implementation, calculation steps executed in the open world, other steps in computers of the certified avionics and potentially in computers on the ground;
to be able to support addition or removal of new services;
enrichment of the steps of searching for solutions by way of databases;
being based on an ontology to succeed in formalizing expert know-how and/or collect information on the flight context and allow a decision-making process to be engaged in order to end up with a suggestion;
to be able to propose multiple solution algorithms in parallel;
to have a weighting mechanism for proposing a suggestion or taking a decision;
to record the device usage data in flight in order to improve the suggestions proposed to the pilots by reinjecting them into the device's databases.

1. A method for assisting in the piloting of an aircraft during a mission, the method being implemented by computer and comprising:
steps implemented by a competency module comprising a plurality of application components called capabilities, each capability having a competency domain characterizing its functional domain, the nature and the format of the data relating to this functional domain, and being configured according to one and the same logic format in order to perform, in its competency domain, at least the following functions:
calculating events based on data relating to said functional domain which are acquired from various certified or non-certified avionics sources and/or from various sources external or internal to the aircraft;
processing requests to solve events affecting the current mission of an aircraft, said events being calculated by said capability and/or by other capabilities, said requests being processed based on data relating to said functional domain of said capability which are acquired from various certified or non-certified avionics sources and/or from various sources external or internal to the aircraft;
generating event solution proposals;
steps implemented by an impact processing module consisting in determining the presence of an impact on carrying out the current mission of the aircraft, either for an event calculated by a capability or for a event solution proposal generated by a capability; and
steps implemented by a solution module of:
sending solution requests to one or more capabilities of the competency module;
evaluating event solution proposals;
constructing solutions for adapting the current mission of the aircraft based on at least one event solution proposal.

2. The method according to claim 1, wherein the step of determining the presence of an impact comprises steps of:
calculating a current context of the current mission according to said at least one event; and
determining, according to the current context, the impact on carrying out the current mission.

3. The method according to claim 2, wherein the step of determining an impact according to the current context comprises calculations based on predefined rules and/or calculations based on an ontology.

4. The method according to claim 1, wherein the impact-processing step comprises steps of:
constructing solution requests according to the calculated impact; and
sending said solution requests to one or more capabilities of the competency module in order to query these capabilities according to their competency domain.

5. The method according to claim 4, wherein the step of constructing solutions for adapting the mission additionally comprises steps of:
sorting said evaluated proposals; and
selecting a solution for adapting the current mission of the aircraft for constructing a solution for adapting the current mission.

6. The method according to claim 1, wherein the evaluation step comprises steps of:
calculating a resulting context for the current mission for each solution proposal; and
determining, according to the resulting context, the impact on carrying out the current mission.

7. The method according to claim 6, wherein the determination step comprises calculations based on predefined rules and/or calculations based on an ontology.

8. The method according to claim 1, further comprising a step for displaying the one or more solutions for adapting the current mission of the aircraft on a human-machine interface.

9. The method according to claim 1, comprising steps for recording the competency domain of each application component in a capability register and a capability database.

10. A computer program product, said computer program comprising code instructions for carrying out the steps of the method according to claim 1 when said program is run on a computer.

11. A device comprising means for implementing the method according to claim 1.
